(19) United States
(12) Patent Application Publication
(10) Pub. No.: US 2004/0256421 A1
(43) Pub. Date: Dec. 23, 2004

(54) Container with Alignable Dispensing Openings

(75) Inventor: Elmer D. Werth, Arvada, CO (US)

Correspondence Address: KYLE W. ROST, 5490 AUTUMN CT., GREENWOOD VILLAGE, CO, 80111, US

(73) Assignee: Elmer D. Werth, Arvada, CO (US)

(21) Appl. No.: 10/604,015

(22) Filed: Jun. 20, 2003

(51) Int. Cl. B65D 51/18; B67D 3/00

(52) U.S. Cl. 222/480; 220/253

(57) ABSTRACT

A double closure selectively aligns or non-aligns openings in a container such as a dispensing container. An inner lid provides an inner dispensing opening in an inner closure panel. A seal wall depends from the inner closure panel and fits within the open end of a container in a sealing relationship. An outer lid provides an outer dispensing opening in an outer closure panel. A peripheral wall depends from the outer closure panel, fits over the top of the inner closure panel and fits around the outside face of the container body. Engaging devices between the two lids and between the outer lid and the container body maintain the necessary spacing for the lids to seal against each other when the outer lid is twisted to selectively bring the outer dispensing opening out of alignment with the inner dispensing opening.

### BACKGROUND OF INVENTION

1. Field of the Invention

The invention generally relates to both dispensing and to receptacles such as cans, beverage bottles, and drinking cups. In one aspect, it relates to closures and end wall structures, such as end wall structures of a dispensing can, caps for a bottle, and lids for a drinking cup. More specifically, it relates to dispensing and to closure sections that are relatively moveable, especially to closures that are penetrated through intersecting slits. In more specific detail, it relates to closure members having alignable dispensing openings.

2. Description of Related Art Including Information Disclosed Under 37 CFR 1.97 and 1.98

Lids for many types of containers are provided with an integral closure opening arrangement. According to common practice, a pressurized beverage can lid is scored or otherwise processed to create a frangible line of weakness that defines an opening tab. The container can be opened by fracturing the edge of the tab along the line of weakness. If the frangible line defines a closed geometric figure, the tab can be entirely removed from the lid. However, it has become standard to define an open geometric figure so that the tab is retained on the lid by a continuous bridge. Removable tabs presented a danger because the tab might be sharp and could inflict accidental injury. For this reason, removable tabs no longer are commonly used. Retained tabs offered an improvement because they could be displaced into the container so that the edges are sheltered from accidental contact.

Lids having either a removable tab or a retained tab usually carry an opening ring. The ring is riveted to the lid near one edge of the ring. The ring can be lifted away from the lid at the opposite edge of the ring. The opening ring associated with a removable tab often is called a pull ring. A removable tab is riveted to the pull ring near the frangible line, so that the pull ring can be raised to bend the tab at the frangible line and fracture at least a part of the frangible line. The pull ring can be drawn away from the lid to fracture the remaining portion of the frangible line and pull the tab free of the lid. Retained tabs have a riveted opening ring located near the bridge area to the remainder of the lid. When this opening ring is raised, it fractures the frangible line and pushes the tab downwardly into the container, bending the unbroken bridge.

Lids of this type offer no ability to reseal the beverage, whether to preserve it for later use or merely to protect against spillage or prevent entry of foreign matter. In practical terms, an opening tab that pulls free of a lid is impossible to use for resealing purposes. An opening tab that remains attached to a lid through an unbroken bridge cannot reasonably be resealed because it is bent into the interior of the container. As a practical matter, it is impossible for an unaided finger to raise the tab into sealing arrangement with the pour opening. Thus, despite the convenience of a tab opening on a modern beverage can, there is a continuing need for improvement in the area of re-closing and re-sealing such cans after they are first opened.

Pressurized beverages also are packaged in bottles. Pressurized beverages typically are sealed by a crown lid with a crimped skirt or a screw-down lid. The crown lid has been in wide use for many years. It is opened by prying the lid off of a rounded lip at the bottle mouth, using a leverage tool. In practical terms, crown lids are impossible to reseal, in part because the process of opening the crown lid bends and deforms those lids, and in part because substantially more than hand pressure is required to place the crimped skirt of the crown lid over the lip on the bottle mouth.

Screw-down lids offer versatility because they are removed by hand, without any other tool. In addition, they can be reapplied and resealed. The chief disadvantage is that the screw lid is entirely removed from a bottle and often is discarded as soon as the bottle is open. Thus, the screw-down lid may be lost or contaminated with dirt before the user desires to reseal the bottle. Thus, although screw-down lids offer the ability to re-close and reseal a beverage bottle, there remains a need for a lid that is not so readily lost or contaminated after the initial opening.

Beverage cups, such as disposable cups used by many restaurants and other food vendors, can be sealed with a reasonably leak-proof lid that snaps over a lip of the mouth of the cup. These lids are inexpensive and disposable with the cup. Often these lids include a frangible tab that can be bent or broken away to produce a drink opening or straw access opening. Other lids, such as those intended use with coffee or similar hot beverages, may contain a pre-formed drink opening. Lids for disposable cups do not offer a resealing ability after any drink opening or straw opening has been used. For the reasons mentioned, above, it would be desirable to have an inexpensive, resealable lid for disposable cups.

Primarily as applied to beverage cans and bottles, various resealable lids have been proposed. None is known to be commercially available. Each one appears to suffer practical limitations, whether in high cost, difficult manufacturing technique, inoperability or difficult operability. Primary issues faced in these efforts are how to connect two lids in an operable way, how to create a functional pressure seal between two lids, how to reseal the two lids to maintain residual pressure, and how to reliably attach a twistable lid so that it is not too tight to be hand-twisted, while still maintaining a desired snug fit with the container. The following patents illustrate the best prior efforts to solve there problems.

U.S. Pat. No. 2,172,452 to Rese, issued in 1939, discloses a hermetically sealed metal container of old fashion opener design, but having a lid with a pour opening and a vent opening. A closure strip is riveted to the lid by a rivet formed of the material in the lid wall, and located between the openings. The strip can be rotated between a first position where its opposite ends lie over two openings to re-close them and a second, dispensing position where the strip does not close the openings. The technical requirements for constructing such a lid, properly locating and sealing the closure strip, and allowing the strip to be freed with reasonable hand force, seem poorly developed and may account for this lid being impractical for commercial use.

U.S. Pat. No. 3,726,432 to Gentile, issued in 1973, discloses a metal or plastic container having both an inner and outer lid. The inner lid is united with the side wall. The outer lid includes a skirt with an inwardly projecting rib that is engaged under a top rim of the container. This arrangement allows the outer lid to rotate while being retained on the container. The lids both have an off-center opening, which can be registered or re-sealed as the outer lid is twisted. A severing tool is formed on the lower surface of the outer lid. The severing tool can open a sealing tab on the inner lid by both fracturing a frangible line around the tab and pushing the tab down into the container. Automatic severing tools of this type appear unlikely to function reliably. In addition, applying an outer metal lid firmly enough for the reliable use of a severing tool, while still allowing hand twisting operations, is technically difficult.

U.S. Pat. No. 3,889,842 to Bennett, issued in 1975, shows double convex lids on a metal container. The inner lid is conventionally seamed to the rim. The inner lid defines an inner pour opening that initially is sealed against the outer lid. The inner lid carries a raised button at a location diametrically opposite the pour opening. The raised button extends upwardly through an outer pour opening of the outer lid. The button must be depressed to depress the inner lid into a concave configuration, to unseal the inner pour opening, and to allow the outer lid to be twisted with respect to the inner lid and align the inner and outer pour openings. The outer lid engages the chime by wrapping around its exterior, holding the outer lid at a fixed height while it is twisted. Allegedly, the container may be resealed by twisting the outer lid until the outer pour opening is registered with the diametrically opposite button, whereupon the button is released to raise-up through the outer pour opening, allowing the inner lid to raise back to convex configuration and again seal the inner pour opening against the outer lid. This scheme is technically complex both in the fabrication and assembly of the two lids. Significantly, it offers considerable danger of cut fingers during the opening process. In addition, as noted above, applying an outer lid in a way that is reliably hand-twistable can be difficult. It is doubtful that this scheme would function well enough for commercial use.

U.S. Pat. No. 4,717,039 to Ayyoubi, issued in 1988, discloses a resealing plate for use on a modern retained-tab end, described above. The resealing plate is approximately a half circle mounted on the rivet under the lift ring. Similar to Rese, the plate can be rotated on the rivet, over the pour opening, to reseal the pour opening. The plate also includes a small, soda-straw opening that can be registered with the pour opening, if desired. The requirement of riveting the resealing plate loosely enough to be twisted can be technically unreliable. In addition, the container still requires conventional sealing and unsealing features. The mere addition of a sealing plate offers no advantage in material strength and appears wasteful of materials.

U.S. Pat. No. 5,205,430 to Valyi, issued in 1993, discloses a double lid especially suited for use on a plastic can. An inner lid closes and seals the can and includes an area that can be severed to form an inner pour opening. An outer lid is held by a peripheral, inward facing groove in a raised edge of the inner lid. The outer lid is twistable in the groove to both sever the wall over the inner pour opening and bring an outer pour opening into registration with the inner pour opening. This technology appears limited to plastic cans and suffers the unreliability of an automated severing device.

U.S. Pat. No. 5,289,945 to Stradder, issued in 1994, discloses a cap for a pressurized bottle. One embodiment of the cap is formed of upper and lower sections. The lower section includes an inwardly directed rib that snaps into an annular groove below the lip of a non-threaded bottle neck. A sealing plate closes the top of the lower cap portion and bottle mouth. The sealing plate also includes an off-center pour opening. The upper cap is threaded to the lower cap and includes a pour nipple that is misaligned with the pour opening when the cap is screwed down. The upper cap can be partially unscrewed to register the pour opening with the nipple and dispense the beverage. This cap tends to be costly to mold and complex to operate.

U.S. Pat. No. 5,601,203 to Brun, Jr., issued in 1997, discloses a blow molded plastic beverage can with a double lid and an anti-tamper feature. The inner lid has five successive seal positions that include only two openings, at positions two and four. The outer lid has one pour opening that is registerable with any of the five inner seals. A ratchet between the lids allows one-way movement of the outer lid through positions one through three. The lid is applied while the container is empty, and the sealed container is shipped from manufacturer to filler with the outer lid in position one. In order to fill this container, the filler must rotate the lid to position two, which provides an open fill opening, and then must rotate the lid to sealed position three before shipment to the consumer. The consumer rotates the lid to position four, which provides an open pour opening, and has the option to reseal by rotating to position five. A seal ring at the peripheral edge of the inner lid seals to the outer lid. The complex structures of this container and lid evidently result from a requirement that the lid is applied before the container is filled. This container appears impractical and unusable with conventional filling machines and could not be used on a commercial basis without retooling filling lines.

U.S. Pat. No. 5,692,633 to Gordon, issued in 1997, shows a metal beverage container with a double lid. The outer lid is retained by partially wrapping the chime, engaging the edge of the outer lid in a recess below the chime. Initially, a raised tab with scored outline on the inner lid is covered by a similar raised area of the outer lid. Rotating the outer lid causes an edge of the outer raised area to break the score line of the inner lid, pushing the tab down into the can and thereby opening an inner pour opening. The outer lid includes an outer pour opening that can be registered with inner pour opening for dispensing. A reverse twist re-covers the tab opening with the raised area of the outer lid. The two lids share a rotation limiter—a boss in one is captured in a groove of the other—so that rotation is limited through the useful arc. As noted above, a cap of this type tends to have problems in reliably opening the inner tab and in reliably providing a hand-twistable capability for the outer lid.

U.S. Pat. No. 5,785,213 to Guillot, issued in 1998, discloses a two-part, resealable dispensing lid for a bottle. The inner portion, referred to as a stopper, clamps into an annular groove below the bottle mouth. The stopper provides a central tube communicating with the interior of the bottle and leading to an oblique tube within the stopper. The oblique tube leads to an off-center inner pour opening. The stopper also engages a catch on the bottle neck so that the stopper cannot rotate. The outer part of the lid, referred to as the cap, clamps into an annular recess below the lower edge of the stopper and is rotatable with respect to the stopper. The cap includes an outer pour opening that, in open position, is registered with the inner pour opening of the stopper. When the cap is rotated to closed position, it covers the inner pour opening. It also closes the connection between the central tube and oblique tube of the stopper. Further, the stopper also carries a stub that snaps into the outer pour opening to achieve a triple seal. This cap involves complex molds and corresponding high cost.

U.S. Pat. No. 5,816,427 to Beckertgis, issued in 1998, discloses a double lid in which the outer lid is rotatable. The outer lid includes a depending projection. When the outer lid is rotated, this projection breaks a score line around a frangible tab on the inner lid, opening the tab. A central rivet holds the outer lid to the inner lid. This lid suffers the problems of an automated opener between the lids and of sharing a rivet between a fixed lid and a hand-rotatable lid.

U.S. Pat. No. 6,158,608 to Schlattl, issued in 2000, discloses a sealed metal beverage can with a double lid, one of which is fixed and other is twistable. In different embodiments, the rotatable lid is either the outer lid or the inner lid. In either case, the lids are attached by a traditional central rivet, which also attaches a lift-ring. Further, the perimeter of the rotatable lid engages the fixed lid inside the chime, in what is termed a “snap-ring” engagement for the purpose of keeping the two lids a close enough to maintain a good seal for re-sealing. A seal element surrounds the opening tab. When the outer lid is the rotatable lid, raised structures on the outer lid allow finger engagement for twisting the outer lid. When the inner lid is the rotatable lid, the central rivet is square so that the lift-ring can rotate the inner lid via the rivet, despite its position inside the container. This lid appears to have the problems of riveting two lids when one should be twisted by hand. In addition, it is questionable whether an inner lid can be reliably rotated on a small central structure such as a square rivet post.

U.S. Pat. No. 6,216,904 to Cagan, issued in 2001, discloses a metal beverage container having a fixed inner lid with a permanently open inner pour opening surrounded by an upstanding bead. An outer lid is engaged over the chime to hold it at a fixed height over the inner lid. The outer lid carries a depending bead that, in closed position, surrounds the upstanding bead of the inner pour opening. The outer lid also carries a seal ring that rests on top of the upstanding bead. Finally, the outer lid defines a raised dome in the center of the depending bead. The patent makes the interesting allegation that pressure in the container will press against the fixed inner lid and raise it against the outer lid to apply pressure to the seal ring, preventing the outer lid from being able to rotate. The can is opened by depressing the dome into a concave position, thereby releasing pressure in the container, releasing pressure on the seal ring, and allowing the outer lid to be twisted. The outer lid has an outer pour opening that is rotated into registry with the inner pour opening. The outer lid can be twisted to return the concave dome into registry with the inner pour opening, allegedly restoring a pressure tight seal with the upstanding bead. The technical difficulties in producing and operating this lid appear substantial.

The problems in the prior art are merely mentioned as examples that seem most evident, without being inclusive. Twistable double lids on beverage containers have seen little if any commercial usage, thus limiting the degree to which all problems can be widely known, although strongly suggesting that the problems are pervasive.

It would be desirable to create a lid or closure with alignable openings that operates smoothly and reliably, both to open and to reseal a container.

Further, it would be desirable to create a double closure with alignable openings that can be produced in commercial volumes with acceptably low cost.

As an optional matter, it would be desirable to create a closure with alignable openings that is adaptable to cans, bottles, and still other containers such as disposable cups.

To achieve the foregoing and other objects and in accordance with the purpose of the present invention, as embodied and broadly described herein, the method and apparatus of this invention may comprise the following.

### SUMMARY OF INVENTION

Against the described background, it is therefore a general object of the invention to create a double lid for a dispensing container, which can be smoothly and reliably twisted by hand to open or reseal the container.

According to the invention, a closure selectively seals and unseals the open mouth of a dispensing container body, which is formed of a bottom wall and side wall and defines an open mouth disposed at the top end of the side wall. An inner lid is formed of a first closure panel joined to a seal wall. The first closure panel defines an inner dispensing opening circumscribed by the first closure panel. The first closure panel is applied to the top of the container body open mouth and sized to engage the top edge of the container body side wall at the open mouth and near the periphery of the first closure panel. The seal wall is disposed transversely to the first closure panel, is positioned within the open mouth, and is sized to engage the inside face of the container body side wall juxtaposed to the open mouth in a sealing relationship. An outer lid is formed of a second closure panel joined to a peripheral wall. The second closure panel defines an outer dispensing opening circumscribed by the second closure panel. The second closure panel is applied over the top of the first closure panel and is sized to extend laterally beyond the periphery of the first closure panel. The peripheral wall depends from the second closure panel and is sized to engage the outside face of the container body side wall in a rotatable relationship, at a fixed height with respect to the container side wall, such that the outer lid can be rotated with respect to the inner lid to selectively bring the outer dispensing opening into and out of alignment with the inner dispensing opening.

Another aspect of the invention provides a new dispensing container. A container body is formed of a bottom wall and side wall and defines an open mouth disposed at the top end of the side wall. A closure includes both an inner lid and an outer lid, together selectively sealing and unsealing the open mouth of the container body. The inner lid is formed of a first closure panel joined to a seal wall. The first closure panel defines an inner dispensing opening circumscribed by the first closure panel. The first closure panel is applied to the top of the container body open mouth and sized to engage the top edge of the container body side wall at the open mouth and near the periphery of the first closure panel. The seal wall is disposed transversely to the first closure panel, is positioned within the open mouth, and is sized to engage the inside face of the container body side wall, where the seal wall is juxtaposed to the open mouth in a sealing relationship. The outer lid is formed of a second closure panel joined to a peripheral wall. The second closure panel defines an outer dispensing opening circumscribed by the second closure panel. The second closure panel is applied over the top of the first closure panel and sized to extend laterally beyond the periphery of the first closure panel. The peripheral wall depends from the second closure panel and is sized to engage the outside face of the container body side wall in a rotatable relationship, at a fixed height with respect to the container side wall, such that the outer lid can be rotated with respect to the inner lid to selectively bring the outer dispensing opening into and out of alignment with the inner dispensing opening.

The accompanying drawings, which are incorporated in and form a part of the specification, illustrate preferred embodiments of the present invention, and together with the description, serve to explain the principles of the invention. In the drawings:

### BRIEF DESCRIPTION OF DRAWINGS

FIG. 1 is a vertical cross-section view of the top portion of a container, showing a first embodiment of a container mouth, an inner closure, and an outer closure.

FIG. 2 is a view similar to FIG. 1, showing a second embodiment of the container mouth, inner closure, and outer closure.

FIG. 3 is a view similar to FIG. 1, showing a third embodiment of the container mouth, inner closure, and outer closure.

FIG. 4 is an enlarged detail view of the cross-section surfaces, at the plane 4--4 of FIG. 2.

FIG. 5 is an enlarged detail view of the cross-section surfaces, at the plane 5--5 of FIG. 3.

FIG. 6 is an enlarged detail view of the cross-section surfaces, at the plane 6--6 of FIG. 1.

FIG. 7 is an isometric view of an inner closure similar to those shown in FIGS. 1-3.

FIG. 8 is an isometric view of an outer closure similar to those shown in FIGS. 1-3.

FIG. 9 is an isometric view of a container upper end and mouth similar to those shown in FIGS. 1-3.

FIG. 10 is a vertical cross-sectional view of another embodiment of a container with inner and outer closures, with dimensions and spacing enlarged for clarity.

FIG. 11 is an isometric view of the container of FIG. 10.

FIG. 12 is an enlarged detail view of the cross-section surfaces at plane 12--12 of FIG. 10.

FIG. 13 is an isometric view of an inner closure similar to those shown in FIGS. 10 and 12.

FIG. 14 is a vertical cross-section taken through the plane 14--14 of FIG. 13, with background structure eliminated for clarity.

FIG. 15 is an isometric view of an outer closure similar to those shown in FIGS. 10 and 12.

FIG. 16 is a vertical cross-section taken through the plane 16--16 of FIG. 15, with background structure eliminated for clarity.

### DETAILED DESCRIPTION

The invention provides an improved closure or cover assembly for a dispensing container of a known type formed of a bottom wall and side wall that define a container body that has an open mouth disposed at the top end of the side wall. The closure or cover assembly is formed of an inner cap or lid and an outer cap or lid. The outer lid is twistable with respect to the inner lid about a center point, pivot point, or pivot axis. The container is opened by relative twisting between the two lids to align a dispensing opening in each lid. The container is closed by twisting the two lids to non-align the dispensing openings. The outer lid defines an outer dispensing opening, which is circumscribed by the outer lid and offset from the center point or pivot point of the outer lid. The offset is sufficient to leave a material bridge through the center point and extending to the periphery of the outer lid. The inner lid defines a similarly offset inner dispensing opening with respect to the center point of the outer lid. Thus, the outer lid can be twisted about the center point to bring the outer dispensing opening into alignment with the inner dispensing opening to create a common dispensing opening communicating between the interior and exterior of the container.

Similarly, the outer lid can be twisted to bring the outer dispensing opening into non-alignment with the inner dispensing opening, such that no common dispensing opening is present. Thus, the container is opened or closed by twisting the outer lid with respect to the inner lid and the remainder of the container. The invention offers an improved closure of this described type, which functions reliably and smoothly so that commercial usage is possible. The container can be filled with conventional filling equipment as widely found in present commercial filling lines.

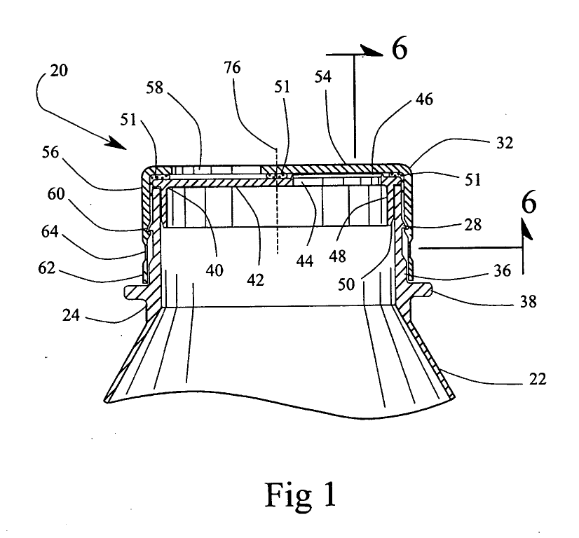

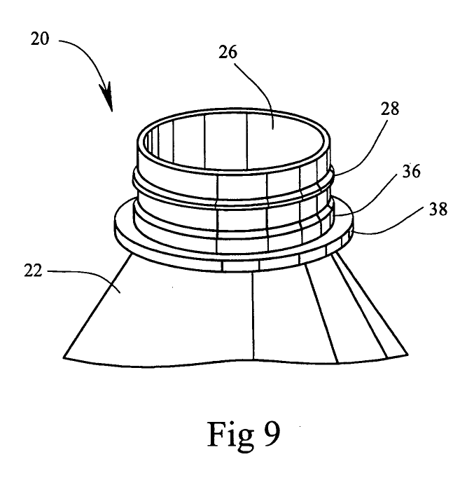

With reference to the drawings and especially to FIGS. 1, 2, 4, and 6-9, a container 20 provides a container body 22 defining an interior volume and an open top. The container is suited to contain liquid or other contents, which may include a carbonated liquid. Such a container body may be of a type defined by a side wall 24, with an open top or mouth 26. The container body may be a can body, a bottle, a cup, or still another type of container. Accordingly, the material of formation may be metal, glass, plastic, composite, or a paper product.

The container may be formed by any presently known or future technology. The container 20 may be of the two-piece style, in which a bottom and side wall are formed of a single sheet of forming material, and which in the prior art typically was later closed by a single lid. Alternatively, the container body may be of the three piece style, in which the side wall is a separate piece, the bottom wall is another separate piece, and which in the prior art typically was later closed by a single lid.

While the shape and structure of the container body is variable, the side wall 24 juxtaposed to container mouth 26 may be generally cylindrical, as often found in commercial container structures. In particular, the inside face of wall 24 may be cylindrical, although other shapes such as ellipses offer special advantage within the scope of this invention. For example, a non-cylindrical, asymmetric, or elliptical shape may be preferred in order to fit a matching non-cylindrical, asymmetric, or elliptical inner lid. An asymmetric inner lid is prevented by the asymmetric shape from rotating with respect to the container body. However, for purposes of example and not limitation, the invention will be described as applied to an inside face of wall 24 at mouth 26 that is formed of parallel side wall portions, such as vertical side wall portions in the orientation illustrated in FIGS. 1-3.

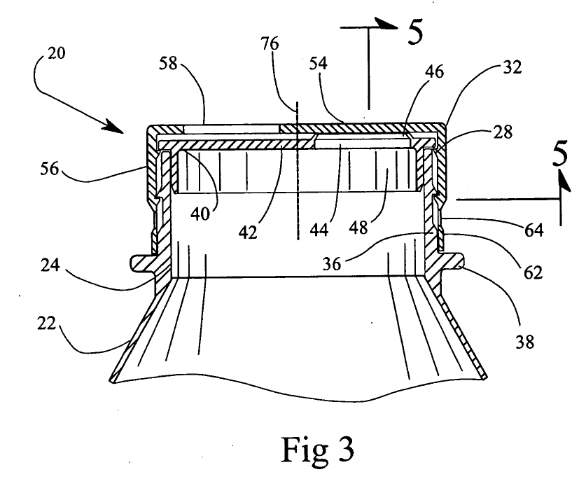

The outside face of wall 24 is preferred to be generally cylindrical. The outside face of wall 24 provides a means for engaging a surrounding wall of a twistable outer lid, which benefits from a cylindrical mounting surface. For example, wall 24 may carry an annular hook, notch, or rib 28 at a preselected distance below the mouth 26 of wall 24. Relative to the position shown in FIGS. 1 and 3, rib 28 is defined by a frusto-conical upper surface 30 flaring from top to bottom, suitably configured for guiding an outer lid or cap 32 over the rib. For this purpose, the frusto-conical surface 30 may be disposed at an angle of approximately thirty degrees to the cylindrical wall 24. The guide surface is useful if the outer lid is to be applied by vertically pressing the lid over the mouth 26.

The rib 28 is an example of a first means for latching and spacing the inner and outer lids in a desired spatial relationship to each other and to the container body 22. At the lower end of surface 30, the rib has a lower surface 34 configured for latching the outer lid or cap 32 in place by a cooperating latching element on the outer lid. For example, the outer lid may provide a lip or recess that engages rib 28. For this purpose, the surface 34 is disposed at approximately ninety degrees to cylindrical wall 24, defining a suitable catch for retaining the outer lid 32.

Below rib 28, the outer surface of wall 24 provides a cooperating portion of a tamper-proof feature. Wall 24 depends until it defines an annular widened area 36 for supporting the lower end of outer lid 32. The widened area may be toothed or otherwise configured for non-rotatably engaging a safety collar of outer lid 32.

Below widened area 36, the outer surface of wall 24 forms a peripherally extending wall, such as an annular flange 38 at a preselected distance below the mouth 26. This flange is useful for handling a container. It is positioned below the mouth 26 by sufficient height to allow application of outer lid 32 and to protect the lower edge of the outer lid from damage in handling.

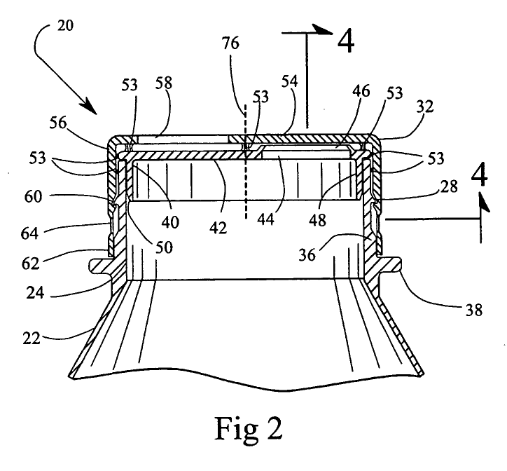

The mouth 26 of container body 22 is closed by an inner lid 40. In the embodiment of FIGS. 1 and 2, the inner lid 40 includes an inner top closure panel 42 that may be generally planar. Panel 42 has a peripheral shape approximately matching the outer profile of wall 24 at the container mouth 26, such that the closure panel rests on the open top end of wall 24 at mouth 26. The closure panel 42 defines an inner dispensing opening 44 that is circumscribed by closure panel 42. At the periphery of opening 44, the top of the closure panel 42 defines a generally upstanding seal 46 that cooperatively seals against the outer lid. Various embodiments of the seal are described below. The dispensing opening 44 occupies less than one-half the area of closure panel 42 and is offset to one side of a center point of the panel 42.

Inner lid 40 includes a transversely disposed skirt or seal wall 48 approximately matching the shape of mouth 26. The skirt 48 may depend from the lower face of closure panel 42 in a perpendicular relationship. The skirt 48 is of suitable size and shape to be snugly inserted into mouth 26 in a pressure sealing relationship. Thus, if mouth 26 is elliptical or otherwise non-cylindrical, skirt 48 should be of approximately matching contour. The lower outside edge 50 of the seal wall 48 may be tapered or chamfered for guiding the wall 48 into mouth 26 during insertion.

When the inner lid is fully applied to mouth 26, the inner lid contacts side wall 24 both by the outer face of seal wall 48 and by the lower peripheral edge of top panel 42. These contact surfaces provide a frictional seal that resists twisting of the inner lid. In additional to the contact friction, any of the contact surfaces may be textured for increased friction or physical interference against relative twisting between the inner lid 40 and container body 22. Further, a sealant 51 or weld 53, best shown in FIGS. 1, 2, 4 and 6, may be applied or formed between the inner lid and container body 22, both to prevent relative twisting and to seal against pressure loss from within the container 20. Thus, the inner lid is prevented from rotating with respect to the container body 22 by geometric fit, high friction surfaces, sealant, adhesive, or any combination of these.

An outer lid 32 is applied to container body 22 over inner lid 40. The outer lid 32 includes an outer closure panel 54 and a peripheral wall 56. The outer lid 32 or outer closure panel 54 may be viewed as having a center point axis of rotation, shown by centerline 76 in FIG. 1. For convenience of reference, the inner lid also may be viewed as having such a center point on the axis of rotation 76, at the intersection of axis 76 through the inner closure panel. The center point provides a convenient reference for describing the relative rotation between the two lids and for describing the relative positions of the dispensing openings in each lid.

The outer closure panel 54 is generally planar and defines an outer dispensing opening 58. The outer dispensing opening preferably is identical in size and shape to inner dispensing opening 44. The outer dispensing opening is offset from the center point of the outer closure panel.

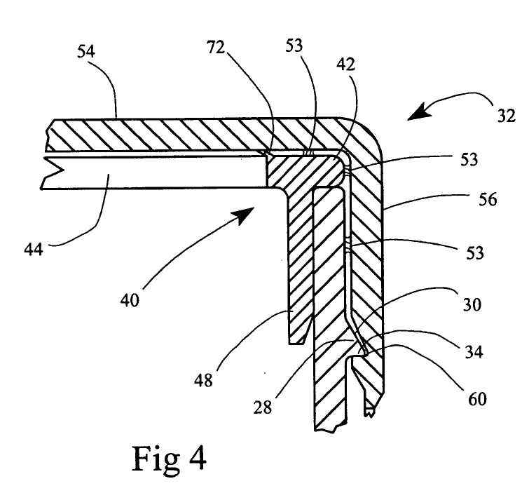

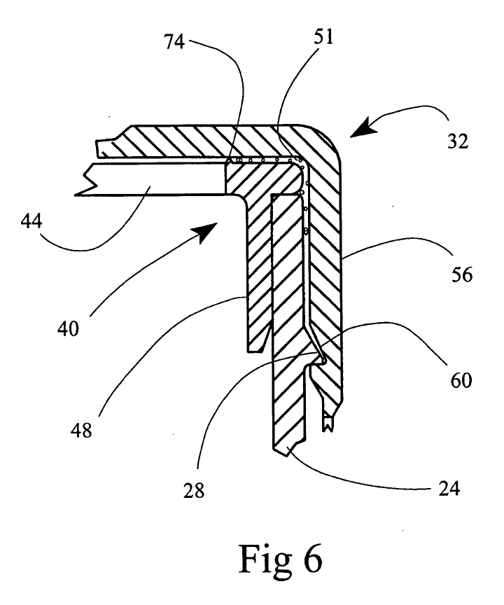

Sealant 51 and welds 53, if used, may be located between the inner and outer lids, over the interface between the inner lid and the container wall, and between the outer lid and container wall. Sealant 51, shown in FIGS. 1 and 6, may be peripheral to the positions of the outer and inner dispensing openings, so that the openings can communicate with the interior of the container body only after the sealant is broken. Welds 53 may be positioned between the outer lid 32 and the container side wall 24, or between the outer lid 32 and the inner lid 40, best shown in FIGS. 2 and 4. Sealant 51 or a weld 53 may be located on the centerline 75 between the inner and outer lids as an especially effective tamper-proof indication that, nevertheless, is easily fractured when the outer lid is twisted. Both the use of sealant 51 and welds 53 are optional methods of sealing and providing tamper-proof indications. Both can be broken by twisting the outer lid with respect to the inner lid.

Peripheral wall 56 is attached to a peripheral edge of closure panel 54 at a transverse or normal angle. In the embodiment of FIGS. 1 and 2, peripheral wall 56 depends from panel 54 at a normal angle. Wall 56 extends over the outside of container side wall 24 from mouth 26 to approximately flange 38. The outer lid includes a means for cooperatively latching to the container body at a fixed or predetermined relative height. For example, at a predetermined distance below closure panel 54, the inside surface of wall 56 defines a latching element, such as an annular rib, hook, or groove 60 configured to provide a latching edge to engage under rib 28 on container body 22. As illustrated in FIG. 1, the shape of such an annular groove may be a negative of the shape of rib 28, with added clearance to allow reliable engagement. The spacing of the latching element is preselected to provide a sealing fit against the inner lid.

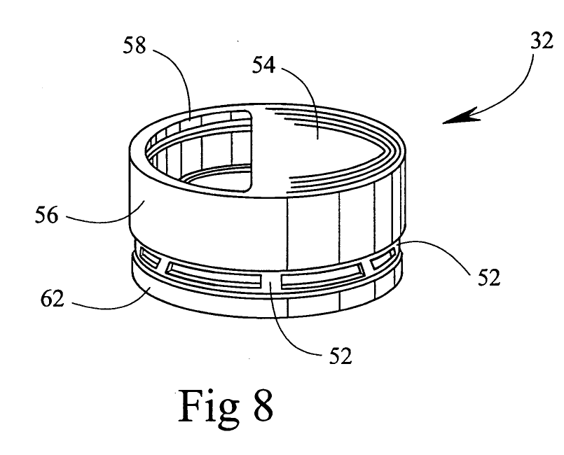

The outer lid may include a tamper-proof mechanism cooperating with the tamper-proof feature of the container body 22. The lower end of peripheral wall 56 carries a safety collar 62, which may be contoured to engage the widened portion 36 of wall 24 in a non-twistable relationship. Between the safety collar 62 and notch 60, the peripheral wall may define a frangible band or shear ring 64. In this area, the wall thickness of wall 56 may be reduced, or the wall 56 may be discontinuous, perforated, or scored so that the outer lid will show when it has been twisted with respect to the container body 22. FIG. 8 illustrates one embodiment of a frangible seal employing spaced shear strips 52 separated by open or severed areas. This or other tamper-proof mechanism can be used to ensure that commercially filled containers such as cans and bottles have not been pre-opened.

The inner and outer lids are held in fixed spacing for proper functioning of sealing elements. The relative positioning of rib 28 and groove 60 maintains a close, sealing engagement between the two lids. The two caps are applied with the dispensing openings out of alignment, so that the inner dispensing opening is sealed against the outer closure panel. The outer lid is twistable by hand for rotation about center point to bring the inner and outer dispensing openings into alignment. The container 20 is resealable by twisting the outer lid to bring the two dispensing openings into non-alignment.

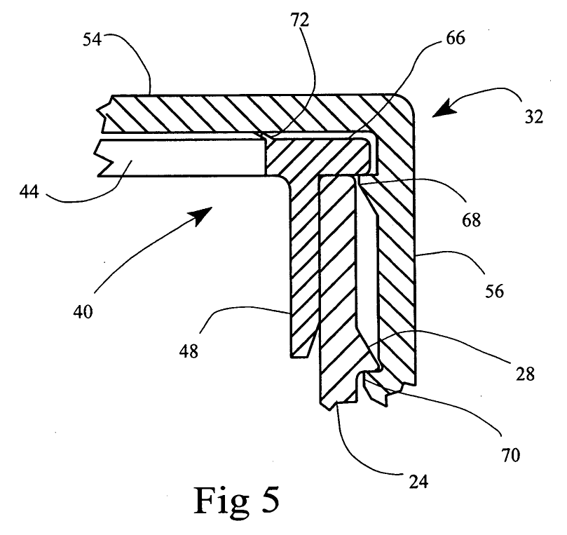

The embodiment of FIGS. 3 and 5 includes many features of FIGS. 1 and 2, with a double latching means or retention mechanism between the inner and outer lids. As best shown in FIG. 5, the inner lid 40 includes a peripherally extending shoulder 66 on inner top panel 42. The shoulder 66 extends laterally beyond side wall 24 at mouth 26. The lower face of panel 42 defines an engagement surface for a rib on the inside face of peripheral wall 56. Thus, FIG. 5 shows that peripheral wall 56 includes two vertically spaced apart engaging devices, such as upper rib 68 and lower rib 70. These two ribs respectively engage below shoulder 66 rib 28.

FIG. 5 also shows details of a seal 72 at the periphery of inner dispensing opening 44. The seal extends upwardly from inner closure panel 42 and toward the open area of dispensing opening 44 in an upwardly and centrally angled frusto-conical configuration. The double latching means of FIG. 5 provides reliable and consistent relative vertical positioning between the inner and outer lids for proper functioning of seal 72. The spacing achieved between shoulder 66 and rib 68 creates a direct spacing relationship between the inner and outer lids. The spacing achieved between rib 28 and rib 70 creates a direct spacing relationship between the container body 22 and outer lid 32. In some cases, the inner lid 40 may be caused to adjust its vertical position in order to maintain the seal with outer lid 32. In such cases, the depending seal wall 48 provides a continuous pressure seal with the container wall 24.

FIG. 4 shows a seal 72 in the embodiment of FIGS. 1 and 2. A single latching means unites and spaces the inner and outer lids. As previously described, the cooperative elements of the latching means may be a rib 28 and groove 60, or a pair of opposed ribs or hooked edges. In particular, a downwardly hooked rib 28 on one of the opposed walls engages with an upwardly hooked rib 70, or within a suitably shaped groove 60 on the opposite wall.

FIG. 6 shows another embodiment of a seal in the structural environment of FIG. 4. A seal 74 is an upstanding rib of approximately triangular cross-section, as viewed in FIG. 6. This seal also is suited for use in the double latching structure of FIG. 5. Such a seal element 74 may be referred to as a weld point.

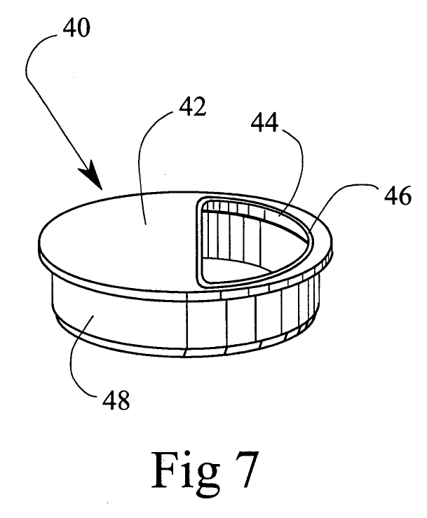

As best shown in FIGS. 7 and 8, the preferred dispensing openings in the inner and outer lids are in the shape of a circle arc truncated by a chord. The arc of each circle segment is less than one hundred eighty degrees. Each circle segment is of diameter less than the inside diameter of the pressure seal wall 48. The dispensing openings are positioned in the circular top panels 42 and 54 between the center point of each panel and the position of the seal wall 48, but offset from both.

A comparison of FIGS. 7 and 8 shows that the lids can be oriented in a sealing position in which the dispensing openings are offset on opposite sides of the center point. Twisting the outer lid can align the openings on the same side of the center point. The offset of each dispensing opening from the center point ensures that an unbroken strip of lid material will separate the dispensing openings 44 and 58 when the lids are positioned in sealing position.

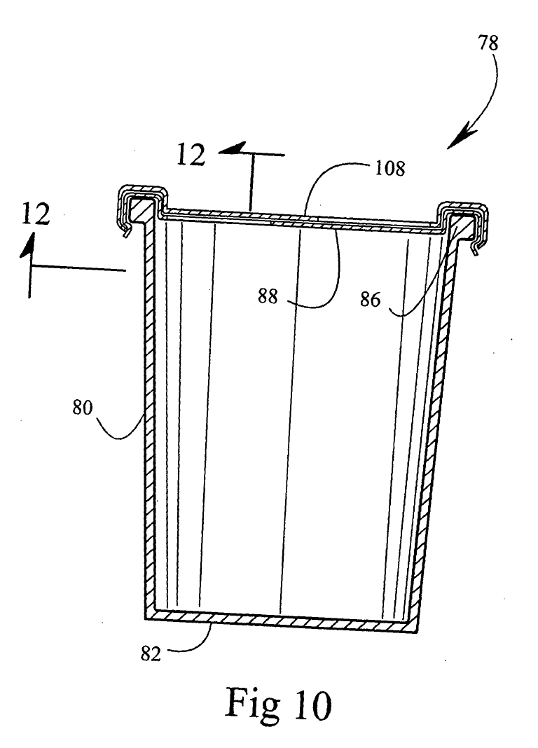

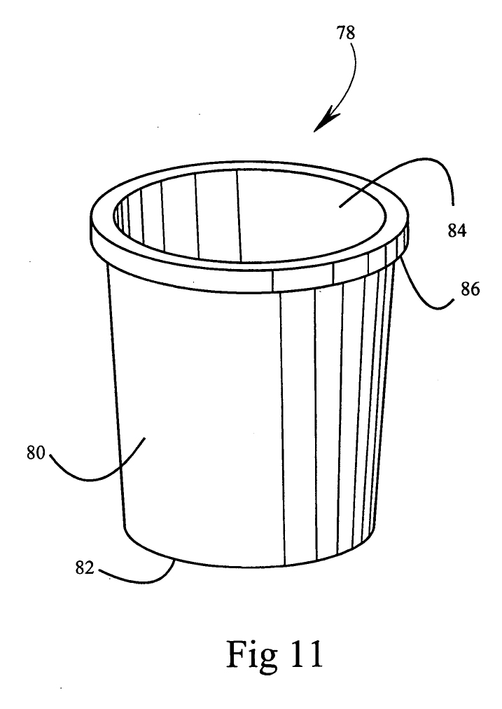

The invention is adaptable to beverage cups and lids of type generally considered to be single use and disposable. FIGS. 10 and 11 show such a disposable cup body 78 formed of a side wall 80 that is relatively narrower at a base wall 82 and wider at the open mouth 84. The mouth may be defined by a rolled lip 86 as often found in paper cups, including paper cups coated with wax or plastic. Hot drink cups, such as molded cups of Styrofoam plastic, do not have such a rolled lip. Molded plastic cups often have a lip. The lid system can be applied to any of these cups, including those without a rolled lip, due to the flexibility of the lids.

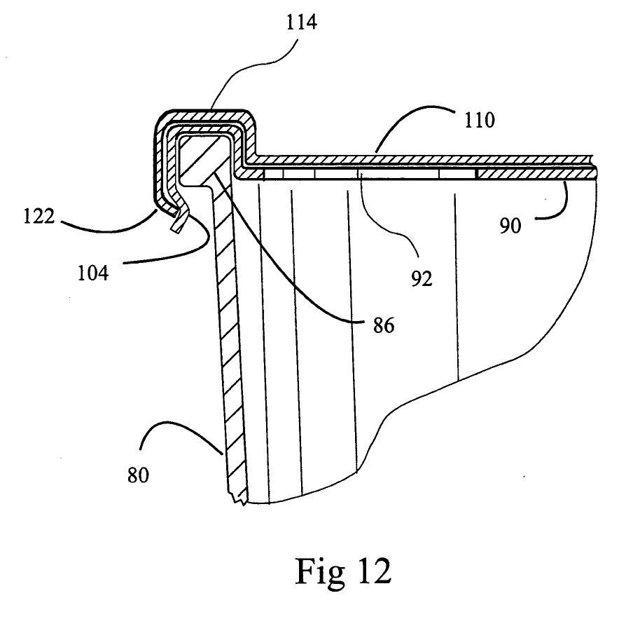

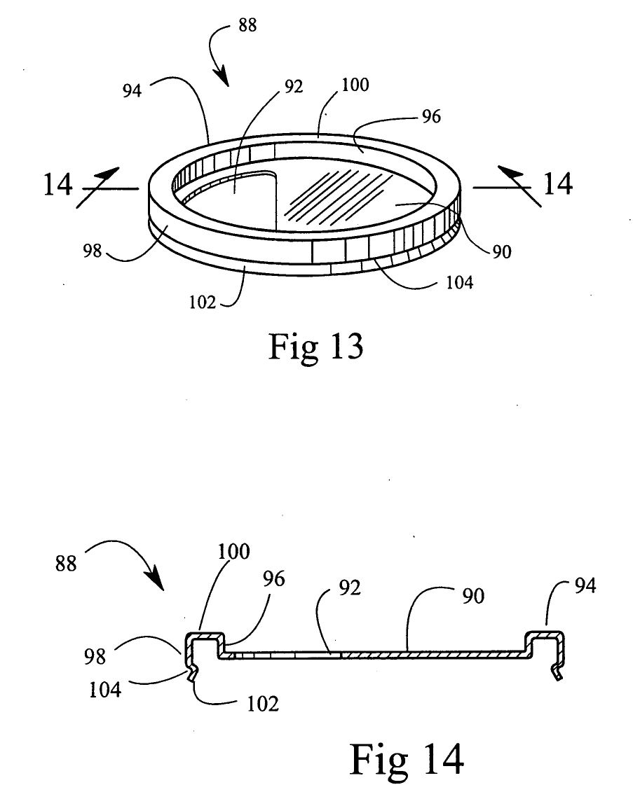

FIGS. 12-14 show modified versions of the closure that are adapted to the needs of a disposable cup and to the variations of shape that are found in such cups. An inner lid 88 includes an inner central closure panel 90 defining and circumscribing a drink opening 92. The central panel lies approximately along a first plane. The periphery of the inner lid carries a transverse seal wall 96 that engages the inside surface of the cup body side wall at a position juxtaposed to the rolled lip or any other lip of a cup.

The transverse seal wall 96 interconnects the central panel 90 to an extension panel 100, which may be disposed in the same plane as panel 90 or in a second plane that is vertically offset from the plane of panel 90. The extension closure panel 100 is preferred to be offset vertically above panel 90 so that seal wall 96 is reinforced at both its top and bottom by portions of the closure panels 90, 100. The seal wall 96 is preferred to have a cylindrical shape on a cylinder axis perpendicular to panels 90, 100.

The seal wall 96 is formed as part of an annular housing 94 that engages a majority of cup lip 86. For example, a lip housing 94 includes the upstanding seal wall 96 forming an inside wall of the housing. The inner wall 96 extends upwardly from closure panel 90 to provide easy application to the cup by hand. The housing 94 also includes an outside wall 98 that depends from top extension wall 100 to receive lip 86 in the housing. In this configuration, top extension wall 100 functions as an extension of closure panel 90 and is located on top of the cup body side wall.

The mating cup lids 88, 108 are joined together in relatively rotatable relationship by any of several means. These means employ mating structures that permit rotation. Suitable structures are similar to tongue-and-groove, engaged ribs, ribs engaged in a groove or channel, channel and channel follower, and the like. In such structures, it is possible to employ continuous annular ribs or channel followers. In some cases, the ribs or channel followers may be segmented or otherwise discontinuous. One suitable structure shown in FIG. 14 is a downwardly and outwardly extending end wall portion 102 that forms outwardly facing channel 104 below housing 94. This channel receives a channel follower associated with the other lid of the mated pair, as described below.

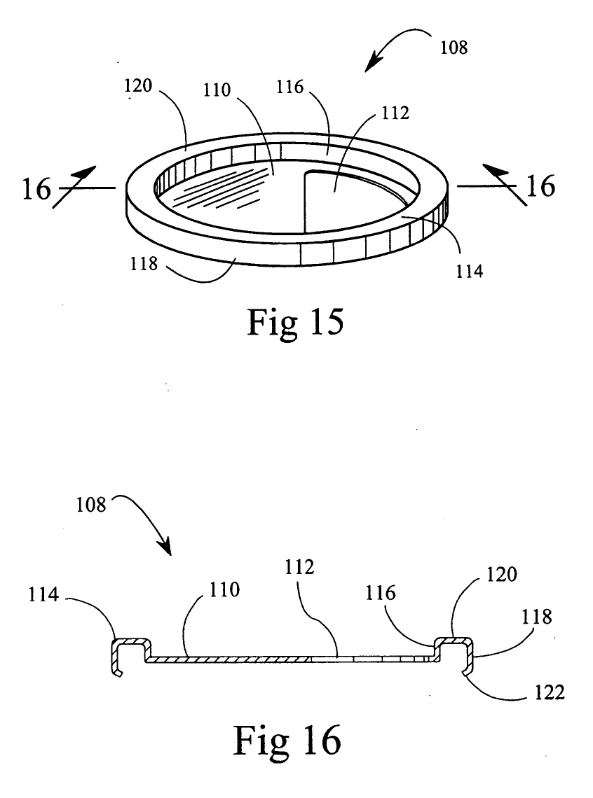

FIGS. 12 and 15-16 show an outer lid 108 that is similar in shape to inner lid 88 and is sized for a snap-fit over lid 88. The outer lid includes a generally planar central closure panel 110 that defines and circumscribes a drink opening 112. This central panel 110 is similar in size and configuration to panel 90. An annular continuation wall 120 lies in an approximately parallel plane, vertically offset from the plane of panel 110, and laterally extending at least to the peripheral edge of wall 100. An upstanding linking wall 116 connects panel 110 to continuation wall 120. An outside, peripheral wall 118 depends from the outer edge of continuation wall 120, over wall 98. Thus, the outer lid forms an outer annular housing 114 sized and positioned to receive inner annular housing 94. In this configuration, top continuation wall 100 functions as an extended portion of closure panel 110. Outside wall 118 is transverse to top wall 120 and closure panel 110. Outside wall 118 may be perpendicular to continuation wall 110. The bottom face of housing 114 is substantially open.

The outside wall 118 includes a resiliently biased, inwardly extending channel follower wall portion 122. For example, wall 122 may extend downwardly and inwardly from the lower end of wall 118. Wall portion 122 is received in channel 104 of end wall 102 and is biased against the inside surface of channel 104. This channel follower wall portion 122 of wall 118 spaces the outer lid 108 with respect to both the inner lid 88 and the cup body 78. The contact between wall 122 and channel 104 better enables the outer lid to be twisted with respect to the inner lid in two ways. First, channel follower 122 and channel 104 are coordinated in size, such that the contact of wall 122 in channel 104 holds open outer housing 114 from tightly gripping lip housing 94. Second, channel follower wall 122 pushes into channel 104 under bias pressure, increasing the grip of lip housing 88 on the cup lip 86. In this way, the outer lid 108 reliably can be twisted with respect to the inner lid 88. The drink openings can be aligned and non-aligned as described, above.

The engagement between the inner and outer housings 94, 114, including the engagement of channel follower wall 122 in channel 104, maintains a close spacing between the inner panel 90 and outer panel 110. This close spacing ensures a good seal between the inner and outer lids when the inner and outer drink openings are in relatively non-aligned positions.

The relative positions of the channel follower wall 122 and the channel 104 can be reversed between the inner and outer lids. Thus, for example, the channel 104 can be connected to the outer lid, such as to the free end of wall 118. In this configuration, the channel is positioned with its open face facing the side wall 80 of the cup 78. Correspondingly, the channel follower wall 122 can be connected to the outside wall 98 of inner lid 88, angling away from cup wall 80 and engaged in the channel 104. In this configuration, wall 118 would continue to be biased inwardly, toward cup wall 80.

The use of a laterally open channel and engaged channel follower structure may be considered optional. The housings 94 and 114 also constitute engaged channel and channel follower structures between a mated pair of lids, wherein the channel is open at its bottom. The housings maintain a fixed vertical spacing between the two lids while allowing relative rotation. Two similar lids 88 or 108 can be mated by matching housings 94 or 114 in rotatable relationship that allows a pair of drink openings 92 or 112 to be rotated between aligned and non-aligned positions.

The forgoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention.

1. A dispensing closure for selectively sealing and unsealing the open mouth of a container body formed of a bottom wall and side wall and defining an open mouth disposed at the top end of the side wall, comprising:
an inner lid formed of a first closure panel joined to a seal wall, wherein:
the first closure panel defines an inner dispensing opening circumscribed by the first closure panel, the first closure panel is applied to the top of the container body open mouth and sized to engage the top edge of the container body side wall at the open mouth and near the periphery of the first closure panel, and the seal wall is disposed transversely to the first closure panel, is positioned within the open mouth, and is sized to engage the inside face of the container body side wall juxtaposed to the open mouth in a sealing relationship; and
an outer lid formed of a second closure panel joined to a peripheral wall, wherein:
the second closure panel defines an outer dispensing opening circumscribed by the second closure panel, the second closure panel is applied over the top of the first closure panel and sized to extend laterally beyond the periphery of the first closure panel, and the peripheral wall depends from the second closure panel and is sized to engage the outside face of the container body side wall in a rotatable relationship, at a fixed height with respect to the container side wall, such that the outer lid can be rotated with respect to the inner lid to selectively bring the outer dispensing opening into and out of alignment with the inner dispensing opening.

2. The closure of claim 1, further comprising:
means establishing a fixed spacing between said first closure panel and said second closure panel for sealing said inner dispensing opening against the second closure panel when the inner and outer dispensing openings are in non-aligned position.

3. The closure of claim 1, wherein:
said second closure panel is connected to said peripheral wall at a fixed relative height;
and further comprising:
means for engaging said first closure panel with said peripheral wall at fixed relative height and allowing relative rotation, establishing a fixed relative height between the first closure panel and second closure panel and sealing said inner dispensing opening against the second closure panel when the inner and outer dispensing openings are in non-aligned position.

4. The closure of claim 3, wherein said means for engaging said first closure panel with said peripheral wall comprises:
a peripheral shoulder on the first closure panel; and
a rib on an inside face of the peripheral wall, spaced below said second closure panel, and maintaining the first closure panel between said rib and the second closure panel.

5. The closure of claim 3, wherein said means for engaging said first closure panel with said peripheral wall comprises:
a peripheral shoulder on the first closure panel; and
a groove formed in an inside face of the peripheral wall, spaced below said second closure panel, and receiving said peripheral shoulder.

6. The closure of claim 1, wherein said seal wall is generally cylindrical and is disposed perpendicular to said first closure panel.

7. The closure of claim 1, wherein said seal wall depends from the bottom face of said first closure panel.

8. The closure of claim 1, wherein said seal wall extends upwardly from the top face of said first closure panel.

9. The closure of claim 1, wherein said first closure panel comprises:
a central panel lying approximately within a first plane;
an extension panel disposed at the outer edge of said central panel, lying approximately within a second plane that is vertically offset from the first plane;
and wherein said seal wall interconnects the central panel and the extension panel.

10. The closure of claim 9, wherein the plane of said extension panel is offset above the plane of said central panel.

11. The closure of claim 9, further comprising:
a laterally open annular channel carried by said extension panel; and
wherein said outer lid includes a laterally inwardly extending annular wall portion engaged in said channel for guiding rotation of the outer lid with respect to the inner lid.

12. The closure of claim 11, wherein said laterally inwardly extending annular wall portion of the outer lid is resiliently biased against said channel.

13. The closure of claim 1, further comprising:
an annular channel structure associated with one of said inner and outer lids; and
an annular channel follower structure associated with the other of said inner and outer lids;
wherein said channel follower structure is engaged in said channel structure, maintaining said first and second closure panels at a fixed relative spacing while permitting relative rotation between the inner and outer lids.

14. The closure of claim 1, wherein said peripheral wall is generally cylindrical and is disposed perpendicular to said second closure panel.

15. The closure of claim 1, wherein said seal wall depends from the bottom face of said second closure panel.

16. The closure of claim 1, wherein said seal wall extends upwardly from the top face of said second closure panel.

17. The closure of claim 1, wherein said second closure panel comprises:
a central panel lying approximately within a first plane;
a continuation panel disposed at the outer edge of said central panel, lying approximately within a second plane that is vertically offset from the first plane;
a transverse linking wall connecting the outer edge of the central panel to the inner edge of said continuation panel;
and wherein:
said peripheral wall depends from an outer edge of said continuation panel.

18. The closure of claim 17, wherein the plane of said continuation panel is offset above the plane of said central panel.

19. The closure of claim 17, further comprising:
a laterally inwardly extending annular channel follower wall carried by said continuation panel;
wherein said inner lid includes a laterally outwardly open annular channel engaging said channel follower wall and guiding rotation of the outer lid with respect to the inner lid.

20. The closure of claim 19, wherein said laterally inwardly extending annular channel follower wall is resiliently biased against said channel.

21. A container, comprising:
a container body formed of a bottom wall and side wall and defining an open mouth disposed at the top end of the side wall;
a dispensing closure including both an inner lid and an outer lid, together selectively sealing and unsealing the open mouth of said container body;
wherein:
said inner lid is formed of a first closure panel joined to a seal wall;
said first closure panel defines an inner dispensing opening circumscribed by the first closure panel;
the first closure panel is applied to the top of the container body open mouth and sized to engage the top edge of the container body side wall at the open mouth and near the periphery of the first closure panel;
said seal wall is disposed transversely to the first closure panel, is positioned within the open mouth, and is sized to engage the inside face of the container body side wall juxtaposed to the open mouth in a sealing relationship;
said outer lid is formed of a second closure panel joined to a peripheral wall;
said second closure panel defines an outer dispensing opening circumscribed by the second closure panel;
the second closure panel is applied over the top of the first closure panel and sized to extend laterally beyond the periphery of the first closure panel; and
said peripheral wall depends from the second closure panel and is sized to engage the outside face of the container body side wall in a rotatable relationship, at a fixed height with respect to the container side wall, such that the outer lid can be rotated with respect to the inner lid to selectively bring the outer dispensing opening into and out of alignment with the inner dispensing opening.

22. The container of claim 21, further comprising:
means establishing a fixed spacing between said first closure panel and said second closure panel for sealing said inner dispensing opening against the second closure panel when the inner and outer dispensing openings are in non-aligned position.

23. The container of claim 21, wherein:
said second closure panel is connected to said peripheral wall at a fixed relative height;
and further comprising:
means for engaging said first closure panel with said peripheral wall at fixed relative height and allowing relative rotation, establishing a fixed relative height between the first closure panel and second closure panel and sealing said inner dispensing opening against the second closure panel when the inner and outer dispensing openings are in non-aligned position.

24. The container of claim 23, wherein said means for engaging said first closure panel with said peripheral wall comprises:
a peripheral shoulder on the first closure panel; and
a rib on an inside face of the peripheral wall, spaced below said second closure panel, and maintaining the first closure panel between said rib and the second closure panel.

25. The container of claim 23, wherein said means for engaging said first closure panel with said peripheral wall comprises:
a peripheral shoulder on the first closure panel; and
a groove formed in an inside face of the peripheral wall, spaced below said second closure panel, and receiving said peripheral shoulder.

26. The container of claim 21, wherein said seal wall is generally cylindrical and is disposed perpendicular to said first closure panel.

27. The container of claim 21, wherein said seal wall depends from the bottom face of said first closure panel.

28. The container of claim 21, wherein said seal wall extends upwardly from the top face of said first closure panel.

29. The container of claim 21, wherein said first closure panel comprises:
a central panel lying approximately within a first plane;
an extension panel disposed at the outer edge of said central panel, lying approximately within a second plane that is vertically offset from the first plane;
and wherein said seal wall interconnects the central panel and the extension panel.

30. The container of claim 29, wherein the plane of said extension panel is offset above the plane of said central panel.

31. The container of claim 29, further comprising:
a laterally open annular channel carried by said extension panel; and
wherein said outer lid includes a laterally inwardly extending annular wall portion engaged in said channel for guiding rotation of the outer lid with respect to the inner lid.

32. The container of claim 31, wherein said laterally inwardly extending annular wall portion of the outer lid is resiliently biased against said channel.

33. The container of claim 21, further comprising:
an annular channel structure associated with one of said inner and outer lids;
an annular channel follower structure associated with the other of said inner and outer lids;
wherein said channel follower structure is engaged in said channel structure, maintaining said first and second closure panels at a fixed relative spacing while permitting relative rotation between the inner and outer lids.

34. The container of claim 21, wherein said peripheral wall is generally cylindrical and is disposed perpendicular to said second closure panel.

35. The container of claim 21, wherein said seal wall depends from the bottom face of said second closure panel.

36. The container of claim 21, wherein said seal wall extends upwardly from the top face of said second closure panel.

37. The container of claim 21, wherein said second closure panel comprises:
a central panel lying approximately within a first plane;
a continuation panel disposed at the outer edge of said central panel, lying approximately within a second plane that is vertically offset from the first plane;
a transverse linking wall connecting the outer edge of the central panel to the inner edge of said continuation panel;
and wherein:
said peripheral wall depends from an outer edge of said continuation panel.

38. The container of claim 37, wherein the plane of said continuation panel is offset above the plane of said central panel.

39. The container of claim 37, further comprising:
a laterally inwardly extending annular channel follower wall carried by said continuation panel;
wherein said inner lid includes a laterally outwardly open annular channel engaging said channel follower wall and guiding rotation of the outer lid with respect to the inner lid.

40. The container of claim 39, wherein said laterally inwardly extending annular channel follower wall is resiliently biased against said channel.

41. The container of claim 21, further comprising:
means establishing a fixed spacing between said container body and said second closure panel for creating a suitably sized spacing to receive said first closure panel between container body and second closure panel in a sealing relationship to the second closure panel when said inner and outer dispensing openings are in non-aligned relationship.

42. The container of claim 22, wherein said means establishing a fixed spacing between said container body and said second closure panel comprises:
an annular laterally extending rib associated with one of said container body and peripheral wall;
an annular rib reception structure associated with the other of said container body and peripheral wall;
wherein said rib is engaged in said rib reception structure, maintaining the container body and second closure panel at a fixed relative spacing while permitting relative rotation between the inner and outer lids.
